(19) United States
(12) Patent Application Publication
(10) Pub. No.: US 2016/0189227 A1
(43) Pub. Date: Jun. 30, 2016

(54) TARGETED ADVERTISING USING A CROSSWALK NETWORK AND WIRELESS PROXIMITY

(71) Applicant: eBay Inc., San Jose, CA (US)

(72) Inventors: Saumil Ashvin Gandhi, Sunnyvale, CA (US); Justin D. Davidson, San Jose, CA (US)

(21) Appl. No.: 14/585,009

(22) Filed: Dec. 29, 2014

(51) Int. Cl. G06Q 30/02

(52) U.S. Cl. CPC G06Q 30/0261

(57) ABSTRACT

A system comprising a computer-readable storage medium storing at least one program and a computer-implemented method for identifying a user device, predicting a path corresponding to the user device, and delivering targeted content to the user device, through the use of a novel crosswalk network.

### TECHNICAL FIELD

This application relates to data processing. In particular, example embodiments may relate to systems and methods for targeted advertising using a crosswalk network and wireless proximity.

### BACKGROUND

Location-based targeted content is delivered to users through a geo-fence. A geo-fence could be dynamically generated—as in a radius around a store or point location. When the location-aware device of a location-based service (LBS) user enters or exits a geo-fence, the device receives a generated notification. This notification might contain information about the location of the device. Conventionally, devices are located through the use of Global Positioning System (GPS) functionality or Global System for Mobile Communication (GSM). These conventional methods may not be effective for devices or areas where GPS and GSM are unavailable.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a network system having a client-server architecture configured for exchanging data over a network, according to an example embodiment.

FIG. 2 is an interaction diagram depicting example exchanges between a client device, a path prediction and advertising application, and a third party server, consistent with some embodiments.

FIG. 3 is a block diagram illustrating an example embodiment of multiple modules forming a path prediction and advertising application, which is provided as part of the network system of FIG.1.

FIGS. 4A and 4B are diagrams depicting a crosswalk network for path prediction, consistent with some embodiments.

FIG. 5 is a flowchart illustrating an example method of predicting a user device path and delivering targeted content, consistent with some embodiments.

FIG. 6 is an interface diagram depicting advertisements delivered to a user device based on a predicted path, consistent with some embodiments.

FIG. 7 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover such alternatives, modifications, and equivalents as may be included within the scope of the disclosure. In the following description, specific details are set forth in order to provide a thorough understanding of the subject matter. Embodiments may be practiced without some or all of these specific details. In accordance with the present disclosure, components, process steps, and data structures may be implemented using various types of operating systems, programming languages, computing platforms, computer programs, and/or general purpose machines.

Aspects of the present disclosure describe systems and methods for targeted advertising using a crosswalk network and wireless proximity. A crosswalk network comprises a plurality of beacons located at crosswalk intersections, wherein each beacon has associated with it its own unique location identification data. By collecting and analyzing the unique location identification data of each crosswalk beacon with a user device, a path, or route of the user device through the crosswalk network can be mapped. A path of a user device is predicted based on location data and device data collected over a trip. The predicted path of the user device is then used to deliver targeted content, including advertisements. For example, a path of a user device may be predicted by gathering location data corresponding to the user device at crosswalks and intersections during a trip. The user device may then be delivered targeted content based on the predicted path of the trip. As used herein, a “user” or an “entity” may be a person (e.g., a human), a business (e.g., a company), an organization, a group of people, a persona (e.g., a fictitious character), a bot, or any combination thereof.

The method may further include generating and causing the presentation of an interface that includes a visual representation of the predicted path, and the targeted content sorted by distance from a current location. This interface may allow a user to navigate through content delivered to the user device. In this manner, the user may be able to quickly and easily compare discounts and advertisements delivered, and easily navigate to a corresponding source of the targeted content.

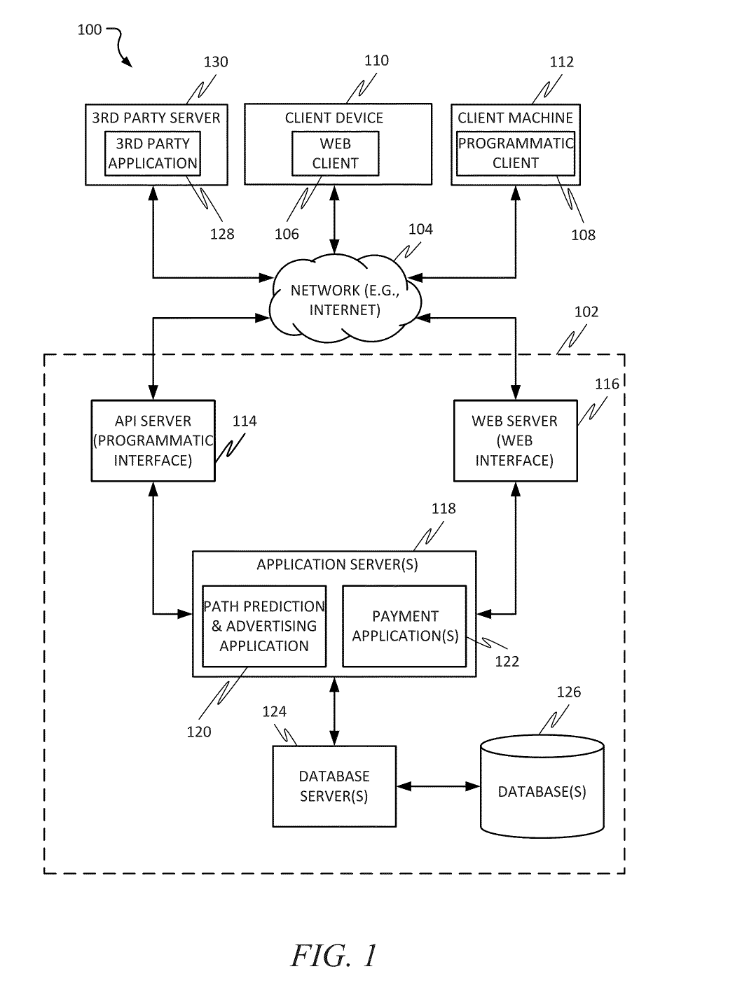

FIG. 1 is a network diagram depicting a client-server system 100, within which one example embodiment may be deployed. A networked system 102, in the example form of a network-based marketplace or publication system, provides server-side functionality, via a network 104 (e.g., the Internet or a Wide Area Network (WAN)), to one or more clients. FIG. 1 illustrates, for example, a web client 106 (e.g., a browser, such as the Internet Explorer® browser developed by Microsoft® Corporation of Redmond, Wash. State) and a programmatic client 108 executing on respective client devices 110 and 112.

An Application Program Interface (API) server 114 and a web server 116 are coupled to, and provide programmatic and web interfaces respectively to, one or more application servers 118. The application servers 118 host one or more path prediction and advertising applications 120 and payment applications 122. The application servers 118 are, in turn, shown to be coupled to one or more database servers 124 that facilitate access to one or more databases 126.

The path prediction and advertising application 120 may provide a number of functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the path prediction and advertising application 120. While the path prediction and advertising application 120 and payment application 122 are shown in FIG. 1 to both form part of the networked system 102, it will be appreciated that, in alternative embodiments, the payment applications 122 may form part of a payment service that is separate and distinct from the networked system 102.

Further, while the client-server system 100 shown in FIG. 1 employs a client-server architecture, the embodiments are, of course, not limited to such an architecture, and could equally well find application in a distributed, or peer-to-peer, architecture system, for example. The path prediction and advertising application 120 and payment application 122 could also be implemented as standalone software programs, which do not necessarily have networking capabilities.

The web client 106 accesses the path prediction and advertising application 120 via the web interface supported by the web server 116. Similarly, the programmatic client 108 accesses the various services and functions provided by the path prediction and advertising application 120 via the programmatic interface provided by the API server 114. The programmatic client 108 may, for example, be a seller application (e.g., the Turbo Lister application developed by eBay Inc., of San Jose, Calif.) to enable sellers to author and manage listings on the networked system 102 in an offline manner, and to perform batch-mode communications between the programmatic client 108 and the networked system 102.

FIG. 1 also illustrates a third-party application 128, executing on a third-party server 130, as having programmatic access to the networked system 102 via the programmatic interface provided by the API server 114. For example, the third-party application 128 may, utilizing information retrieved from the networked system 102, support one or more features or functions on a website hosted by a third party. The third-party website may, for example, provide one or more promotional, marketplace, or payment functions that are supported by the relevant applications of the networked system 102.

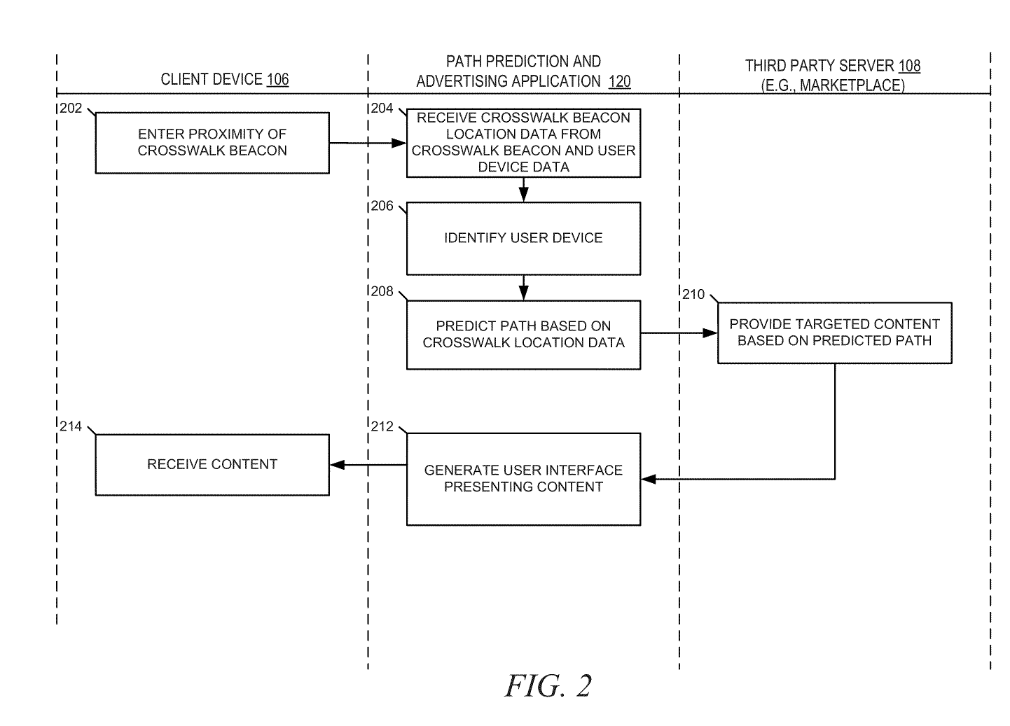

FIG. 2 is an interaction diagram depicting example exchanges between a user device, an application server, and a third-party server, consistent with some embodiments. In particular, FIG. 2 depicts example exchanges between the client device 110, the path prediction and advertising application 120, and the third-party server 130, which, in this example embodiment, corresponds to an online marketplace (e.g., ebay.com). As shown, at operation 202, the client device 110 (the user of which is referred to as the “requesting user” or “requestor”) enters into the proximity of a crosswalk beacon, located at a crosswalk or intersection, and configured to have a unique crosswalk beacon identifier corresponding to its specific location. The crosswalk beacon is configured to detect the presence of user devices within its proximity, and in response to detecting and identifying a user device nearby, to transmit a unique crosswalk identifier to the user device.

At operation 204, in response to entering into the proximity of the crosswalk beacon within a crosswalk network, the client device 110 receives crosswalk beacon location data. In some embodiments, the crosswalk beacon location data is transmitted from the crosswalk beacon via Wi-Fi, Bluetooth, or Radio-Frequency Identification (RFID). In other embodiments, the crosswalk beacon location data is transmitted to the client device 110, responsive to the client device 110 scanning a quick-response (QR) code, or through accessing a unique Uniform Resource Locator (URL) link. In response to receiving the crosswalk beacon location data, the client device 110 transmits the location data, as well as device identification data, to the path prediction and advertising application 120.

At operation 206, the path prediction and advertising application 120 identifies the client device 110 based on the device identification data, which could include various antenna identifiers. The path prediction and advertising application 120 then stores the location data along with the corresponding device identification data. In this way, the path prediction and advertising application 120 can analyze collected location data corresponding to a particular identified user device based on device identification data, and predict the path the user device may take through a crosswalk network. In some embodiments, the path prediction and advertising application 120 predicts the most likely path a user may take through a crosswalk network based on a user transaction and query history corresponding to a user profile associated with the client device 110. The path prediction and advertising application 120 may compare items from a user's transaction and query history with related businesses located along and near the crosswalk network.

For example, the path prediction and advertising application 120 may gather a user transaction history and determine that the user has recently, or frequently purchases Tennis accessories, such as Tennis rackets, Tennis balls, and Tennis shoes. The path prediction and advertising application 120 may then identify that there are related stores located on or near the location of the client device 110 along the crosswalk network which sell Tennis accessories, and that the user is walking in the general direction of the stores. The path prediction and advertising application 120 may then predict that the client device 110 is moving toward the stores. As the user continues on his path, the path prediction and advertising application 120 updates the prediction based on the user's current location, the user's direction of travel, and the user's transaction and query history.

In other embodiments, the path prediction and advertising application 120 may make a prediction of the user's future path based on the path which the client device 110 has traveled through the crosswalk network, by comparing the path the client device 110 has taken with the path taken by other client devices through the crosswalk network. In further embodiments, the path prediction and advertising application 120 may take into consideration the locations of landmarks and concentrations of people along the crosswalk network. For example, the path prediction and advertising application 120 identifies that there is a large concentration of people located at or near a particular intersection. The path prediction and advertising application 120 may then analyze the path taken by the client device 110 through the crosswalk network and identify that the client device 110 shares a similar path taken by users at the identified location, and that client device 110 appears to be moving in the general direction of the location. The path prediction and advertising application 120 may then predict the path which client device 110 would most likely take.

At operation 208, the path prediction and advertising application 120 predicts the path of the client device 110 based on the device identification data, and the corresponding collected location data. In some embodiments, the path prediction and advertising application 120 predicts a final destination for the client device 110. In other embodiments, the path prediction and advertising application 120 predicts ahead a single intersection or crosswalk beacon at a time. In even further embodiments, the path prediction and advertising application 120 generates a dynamically predicted path through the crosswalk network which is updated in real-time as location data is gathered.

At operation 210, based on the predicted path of the client device 110, the path prediction and advertising application 120 queries the third-party server 130 for targeted content to deliver to the client device 110. For example, the third-party server 130 may provide advertisements and coupons corresponding to businesses located on or in proximity of the predicted path of the client device 110.

In other embodiments, the third-party server 130 may incentivize the targeted content based on a corresponding distance from the client device 110. For example, the third-party server 130 may provide greater discounts to a user who is further away from a particular business offering a discount in order to attract the user away from their predicted path.

At operation 212, in response to receiving the targeted content from the third-party server 130, the path prediction and advertising application 120 generates an interactive user interface at the user device. The user interface may further include a field indicating a distance from the client device 110 corresponding to each piece of targeted content delivered. The path prediction and advertising application 120 may be configured to present the targeted content in a particular order, such as content with the nearest corresponding location first, followed by targeted content corresponding to further locations. The user interface may further include GPS navigation functionality, such that a user may select targeted content and then be guided to a particular location corresponding to the targeted content via turn-by-turn directions.

At operation 214, the client device 110 receives the targeted content via a push notification. The user may choose to ignore the targeted content, or select the targeted content for use.

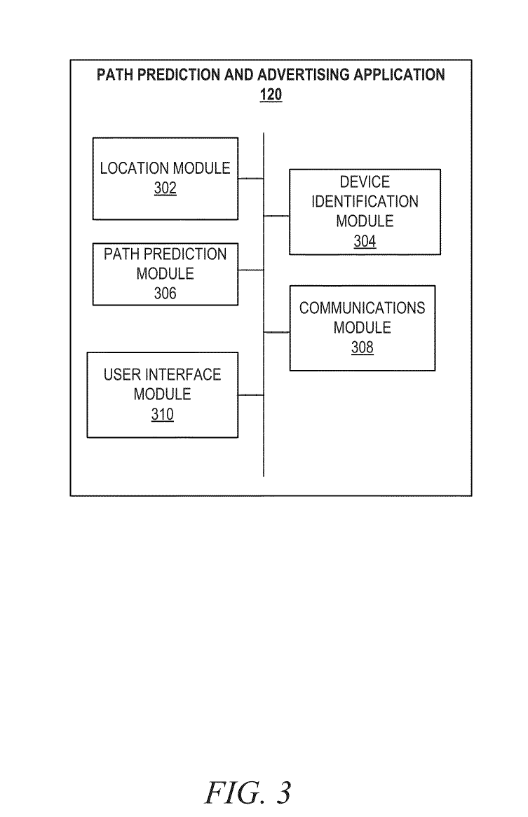

FIG. 3 is a block diagram illustrating various functional modules of the path prediction and advertising application 120, which is provided as part of the client-server system 100, consistent with some embodiments. The path prediction and advertising application 120 is shown as including a location module 302, a device identification module 304, a path prediction module 306, a communications module 308, and a user interface module 310, all configured to communicate with each other (e.g., via a bus, shared memory, a switch, or APIs). The various modules of the path prediction and advertising application 120 may, furthermore, access the database 126 via the database server 124, and each of the various modules of the path prediction and advertising application 120 may be in communication with one or more of the third-party applications 128 (e.g., online marketplace). Further, while the modules of FIG. 3 are discussed in the singular sense, it will be appreciated that in other embodiments multiple modules may be employed.

The location module 302 is configured to collect the unique location identifier from crosswalks, through the network of crosswalk beacons. The unique location identifiers each correspond to a single crosswalk beacon within the crosswalk network, and its corresponding location. For example, in response to a user device approaching a crosswalk beacon, the crosswalk beacon transmits its unique location identifier to the user device. The user device then routes the unique location identifier of the crosswalk beacon to the location module 302, which then identifies the location of the user device based on the unique location identifier data.

As each crosswalk beacon has unique location data, a location for the user device can be determined based on its proximity to a crosswalk beacon.

The device identification module 304 is configured to identify a user device based on one or more identification factors, including antenna identifiers such as a Bluetooth antenna identifier, and a Wi-Fi antenna identifier. The device identification module 304 may then store the collected location data along with the device identifier data in order to plot a path that the user device has taken.

For example, a user device may approach and enter into the proximity of a crosswalk beacon. The crosswalk beacon may be configured to detect the presence of Bluetooth and Wi-Fi antennas. In response to detecting the presence of the Bluetooth and/or Wi-Fi antenna of the user device, the crosswalk beacon transmits its unique location identifier to the user device. The user device may then transmit the unique location identifier along with one or more identification factors to the device identification module 304. Responsive to receiving the location and device data, the device identification module 304 identifies the user device, and stores its corresponding location data alongside the identification data within the database 126, in order to plot and predict its path.

The path prediction module 306 is configured to predict a path of a user device, based on collected location data from a network of crosswalk beacons. The path prediction module may access the database 126 in order to determine a path corresponding to particular antenna identifiers. For example, the path prediction module 306 may access the database 126 and determine that a particular user device having corresponding antenna identifiers has followed a particular path defined by one or more crosswalk beacons which the user device may have passed along its way. With the corresponding location data, the path prediction module 306 may then generate a predicted path which the user device may take, based on its path, the path of other user devices, and a transaction history associated with the user device.

In some embodiments, the path prediction module 306 may be further configured to predict a user's path based on the user's physical orientation with respect to a crosswalk at a corner. For example, should the user be facing a particular direction, the path prediction module 306 may predict that the user will most likely walk in that particular direction.

In other embodiments, the path prediction module 306 may be configured to identify a direction which a user chooses to go through a crosswalk based on a crosswalk button which the user may press, or which has already been pressed. For example, a user may enter the proximity of a crosswalk beacon at a corner. Upon arriving at the crosswalk, the device identification module 304 identifies the user based on their corresponding client device 110. After the user has been identified, the user may press a crosswalk button, indicating that the user wants to cross the street. Responsive to the use pressing the crosswalk button, the crosswalk beacon may transmit directional data to the client device 110, indicating a direction of travel which the user has indicated that they wish to go. The path prediction module 306 may then determine, based on the location data transmitted by the crosswalk beacon, a direction the user wishes to travel across the intersection.

The communications module 308 is configured to receive user inputs from the user, such as inputs via a keyboard or touch-enabled device, as well as voice recognition. The communications module 308 may also be configured to communicate with the third-party server 130 through the network 104 and further, to deliver targeted content to the client device 110.

The user interface module 310 is configured to generate an interactive user interface on the user device, in order to present targeted content to the user, as well as information associated with the targeted content. In some embodiments, the user interface may further include an indicator depicting a distance corresponding to a piece of targeted content, such that the indicator varies the distance with respect to the user's identified location in relation to the location corresponding to the targeted content. The user interface may be configured to present the targeted content to the user device in order of nearest to farthest, and may further include an option to provide the user with turn-by-turn directions to the location corresponding to the targeted content. In other embodiments the user interface may also include a search field, where a user may enter a search query to locate targeted content which has been delivered to the user device.

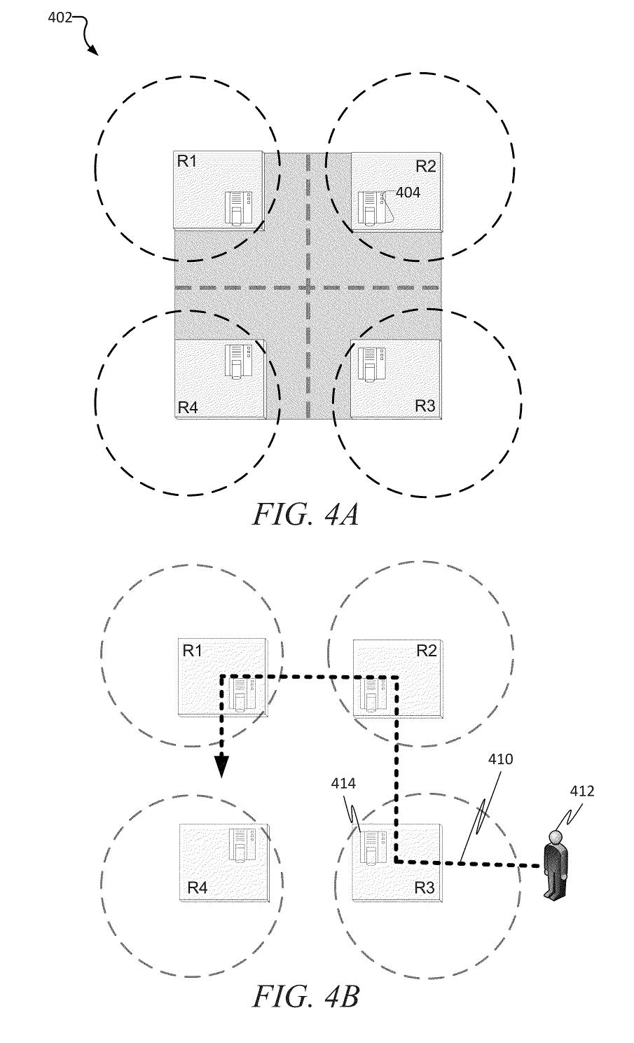

FIG. 4A is an illustration of a crosswalk network 402, consistent with some embodiments. In some embodiments, the crosswalk network 402 is made up of one or more crosswalk beacons 404, which are configured to cover regions R1, R2, R3, and R4. Each crosswalk beacon 404 may comprise a transmitter and a receiver, and has a unique location identifier associated with it, such that the unique location identifier corresponds to a particular region covered by the crosswalk beacon 404. For example, each crosswalk beacon may have associated with it a unique location identifier, which is transmitted to devices responsive to detecting the presence of Bluetooth and Wi-Fi antenna.

In some embodiments, the crosswalk beacon 404 is configured to detect user devices within its proximity based on device identifiers, such as antenna identifiers including Bluetooth identifiers, and Wi-Fi identifiers. For example, as a user device approaches the crosswalk beacon 404 in region R2, the user device is detected and identified based on its Bluetooth identifier and/or Wi-Fi identifier. In response to identifying the user device, the crosswalk beacon 404 then transmits its unique crosswalk beacon location identifier to the user device which routes the location identifier to the location module 302. The location module 302 may then determine the location of the user device.

The crosswalk beacon 404 may also include crosswalk buttons, which a user may press in order to trigger a traffic signal to allow the user to cross the street. The crosswalk beacon 404 in region R2 may further include a button to trigger a traffic signal to enable the user to cross to region R1, as well as a button to trigger a traffic signal to enable a user to cross to region R3. In some embodiments, in response to the user pressing a crosswalk button to trigger a traffic signal, the crosswalk beacon 404 may transmit directional data to the user device, which the user device may then transmit to the path prediction module 306, in order to generate a predicted path of the user device through the crosswalk network.

For example, as a user approaches the proximity of region R2, the crosswalk beacon 404 first identifies the user device based on its antenna identifiers, such as Bluetooth identifiers and/or Wi-Fi identifiers. The crosswalk beacon 404 may then transmit its unique location identifier to the location module 302. The user may then press a crosswalk button on the crosswalk beacon 404, indicating a desire to cross the street from region R2 to region R1. The path prediction module 306 may then receive the directional data from the crosswalk beacon 404, which it may use in conjunction with the location data in order to generate a predicted path for the user device.

FIG. 4B is a diagram illustrating a predicted path 410 taken by a user 412, as discussed above. As the user 412 approaches region R3, a crosswalk beacon 414 identifies a user device corresponding to the user 412. As discussed above, the crosswalk beacon 414 may identify the user device based on the Bluetooth identifier, and/or the Wi-Fi identifier. The user 412 may then press a crosswalk button on the crosswalk beacon 414 indicating a desire to cross the street to region R2. Based on the collected location data corresponding to the user device identification data, as well as the directional data from the user pressing the crosswalk button, the path prediction module 306 may generate the predicted path 410. The communications module 308 may then deliver targeted content in real time based on this predicted path 410, wherein the targeted content includes coupons, advertisements, and special offers.

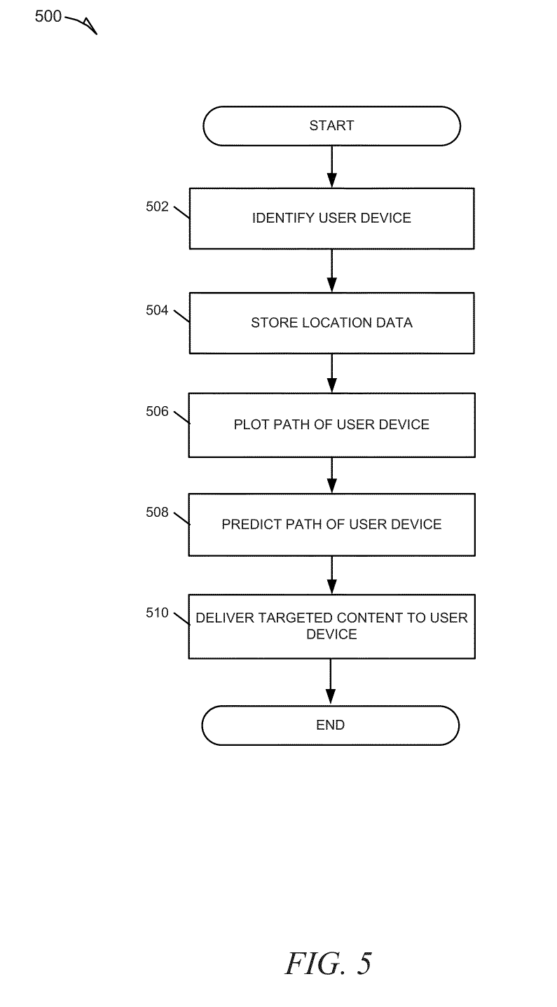

FIG. 5 is a flowchart illustrating an example method 500 to identify a user device, predict a path of the user device, and deliver targeted content to the user device based on the predicted path. The method 500 may be embodied in computer-readable instructions for execution by one or more processors such that the steps of the method 500 may be performed in part or in whole by the application server 118. In particular, the method 500 may be carried out by the functional components of the path prediction and advertising application 120, and accordingly, the method 500 is described below by way of example with reference thereto. However, it shall be appreciated that the method 500 may be deployed on various other hardware configurations and is not intended to be limited to the functional components of the path prediction and advertising application 120.

At operation 502, a user device is identified in the proximity of a crosswalk beacon, located at a crosswalk, by the device identification module 304. In some embodiments, the device identification module 304 identifies the user device based on one or more device identifiers, including the Bluetooth identifier, as well as the Wi-Fi identifier. For example, as the user device approaches the crosswalk where the crosswalk beacon is located, the crosswalk beacon detects the presence of the user device by its Bluetooth identifier and Wi-Fi identifier, which are unique to the user device.

At operation 504, in response to identifying the user device by its unique antenna identifiers, the location module 302 stores the device identification data along with the location data corresponding to the crosswalk beacon at the user device's identified location. In some embodiments, the location module 302 also identifies the direction which the user will most likely go based on which crosswalk button the user presses. The location data is stored along with the device identification data of the user device within the database 126.

For example, upon reaching a crosswalk, a user may press a button on the crosswalk beacon indicating that they wish to cross the street at a certain point, and in a specific direction. The location module 302 stores data corresponding to the direction which the user has indicated that they wish to go, along with the device identification data, and the location data.

In further embodiments, the location module 302 may also identify the orientation of the user, and the direction which they are facing, in relation to the crosswalk beacon. By determining the orientation of the user, the location module 302 may provide further information to the path prediction module 306 in order to generate a predicted path of the user. For example, the orientation and direction of the user device may be determined through use of inertial sensors such as a compass (or magnetometer), a gyroscope, and an accelerometer and previous known traveling directions, and direction history. Also, through the user of front and back facing cameras on the user device, the direction which the user is facing may be determined. The direction and orientation data of the user device may also be stored with the device identification data, for use in generating a predicted path of the user device in real time.

At operation 506, a path which the user device has taken can be plotted by the path prediction module 306, based on the stored location data corresponding to the device identification data. For example, as the user device passes one or more crosswalk beacons, the user device identification data and location data corresponding to the one or more crosswalk beacons are stored in the database 126. A path which the user device has taken over an area past crosswalk beacons may then be plotted and used to generate a predicted path that the user device will most likely take.

At operation 508, the path prediction module 306 generates a predicted path for the user device in real time, based on the data collected by the location module 302 and the device identification module 304, and the path of other user devices with similar paths. For example, by collecting location and device identification data for multiple user devices in the crosswalk network, the path prediction and advertising application 120 can identify high traffic areas, and determine the most common paths, historically, user devices may take through the crosswalk network based on the collected device identification data and location data. In this way the predicted path generated by the path prediction module 306 increases in accuracy as more data is collected.

In some embodiments, the path prediction module 306 may additionally use location data corresponding to landmarks and check-in data corresponding to locations in or around the crosswalk network in order to generate a predicted path. For example, the path prediction module 306 may collect check-in data from surrounding businesses and based on user profile information associated with the check-in, identify attributes associated with those users. Next, responsive to identifying a user device in proximity of a crosswalk beacon, the path prediction module 306 may compare the corresponding user profile information of the identified device with the collected user profile information of users checked-in to various locations in and around the crosswalk network. The path prediction module 306 may then predict a path for the user device based on the check-in data and the corresponding user profile information of the identified user device.

In further embodiments, the predicted path is generated real time, based on location data as it is collected. For example, as a user device approaches a crosswalk beacon, it is first identified by the device identification module 304. Upon the device identification module 304 identifying the user device, the corresponding path which the user device has taken through the crosswalk network, based on the collected location data corresponding to the device identification data, may be analyzed by the path prediction module 306. The path prediction module 306 may then generate a path prediction for the user device, in real-time, based on the paths which other user devices having similar paths through the crosswalk network have taken.

After the path prediction module 306 has generated a predicted path, the location module 302 may update the location data corresponding to the user device based on the data collected in real time. For example, should the location module 302 identify that the user device changes orientation or direction, or that the user has pressed a crosswalk button indicating that they plan on crossing in a certain direction, the additional data may be used by the path prediction module 306 to update the predicted path.

At operation 510, using the most recently generated predicted path by the path prediction module 306, the communications module 308 delivers targeted content. In some embodiments, the targeted content is delivered via a push notification to the user device. For example, as a user is traveling through a crosswalk network, the communications module 308 may deliver targeted content to the user device through an email, text message, or push notification, which the user may then view.

In other embodiments, the targeted content is delivered to display screens located at the crosswalk beacons, which the user may view upon reaching the crosswalk beacon. Upon identifying a user device in the proximity of a crosswalk beacon based on device identifiers, the communications module 308 may deliver targeted content to the display screen at the crosswalk beacon based on the predicted path of the user device.

The targeted content delivered may include coupons, advertisements, and special offers based on the predicted path of the user device. For example, the communications module 308 may deliver targeted content to the user device including coupons, advertisements, and special offers corresponding to businesses located on and along the predicted path of the user device.

In some embodiments, the targeted content may vary based on a distance of the user device from a location corresponding to the content. For example, as a user passes a business corresponding to received content, the communications module 308 may deliver content with greater incentives in order to attract the user off the predicted path. The further that the user travels away from the location, the greater the incentive may become.

In other embodiments, if the user is traveling with another user, the communications module 308 may deliver content including group discounts and special offers. For example, the path prediction module 306 may identify that two or more users share identical or very similar paths through the crosswalk network. In response to the path prediction module 306 identifying that the two or more users are likely traveling together, the communications module 308 may then deliver content including group discounts and special offers for two or more people.

In response to receiving the targeted content to present to the users, the user interface module 310 generates an interactive user interface. The user interface comprises a navigable listing of the targeted content delivered, which the user may select in order to receive further options associated with the content. In some embodiments, the user interface may also comprise a time stamp indicating a time at which the content was received by the user, as well as navigation information to guide the user to a location corresponding to the content.

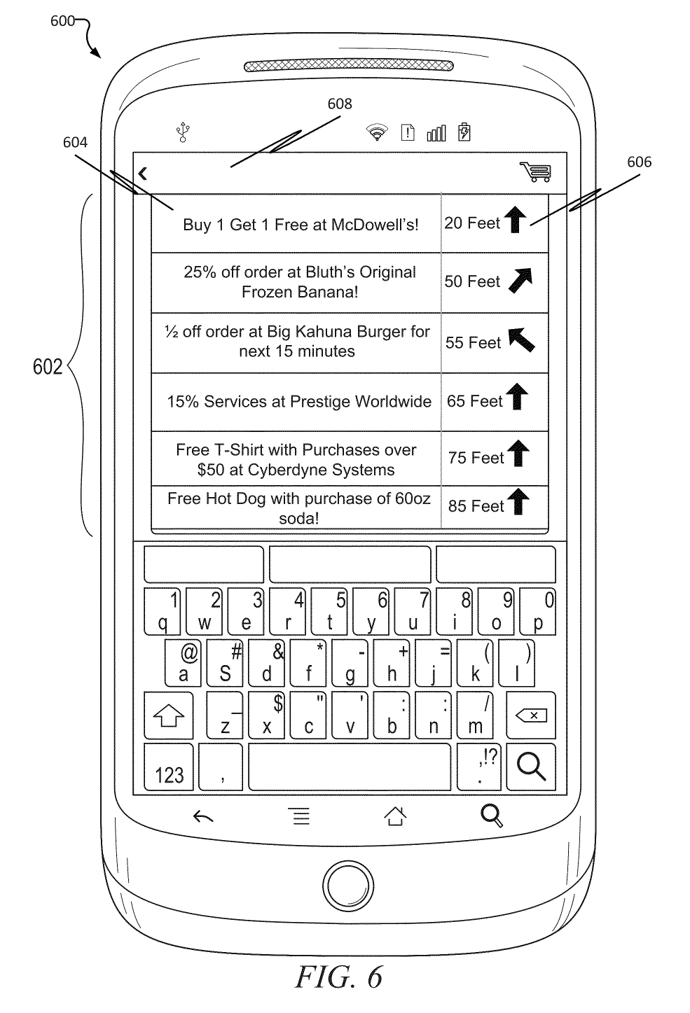

FIG. 6 is an interface diagram depicting a user interface 600 generated by the user interface module 310, comprising targeted content and advertisements delivered to a user device based on a predicted path, as discussed above. In response to receiving the targeted content from the communications module 308, the user interface module 310 generates a list 602 of the targeted content. In some embodiments, the list 602 is organized such that content with the nearest corresponding location is presented first, while in other embodiments the list 602 is in chronological order with respect to when the user received the content.

Each piece of content in the list 602 includes an offer 604, and corresponding location information 606, indicating a distance from a location in which the offer may be redeemed. In some embodiments, the user may “redeem” a coupon or special offer included in the targeted content through a recognized gesture on a touch-enabled device. In further embodiments, in response to a user selecting a particular advertisement or coupon, the user is guided via turn-by-turn directions to the location corresponding to the selected coupon, special offer, or advertisement.

In some embodiments, the user interface 600 also includes a search field 608, which enables a user to search the received content via keywords and phrases. For example, a user may enter the phrase “hamburger,” in the search field 608, which would then generate a list of received content which is associated with hamburgers. In further embodiments, the user may be able to sort the offers based on criteria, such as distance from the user and size of the corresponding incentive, as well as chronologically.

### Example Machine Architecture and Machine-Readable Medium

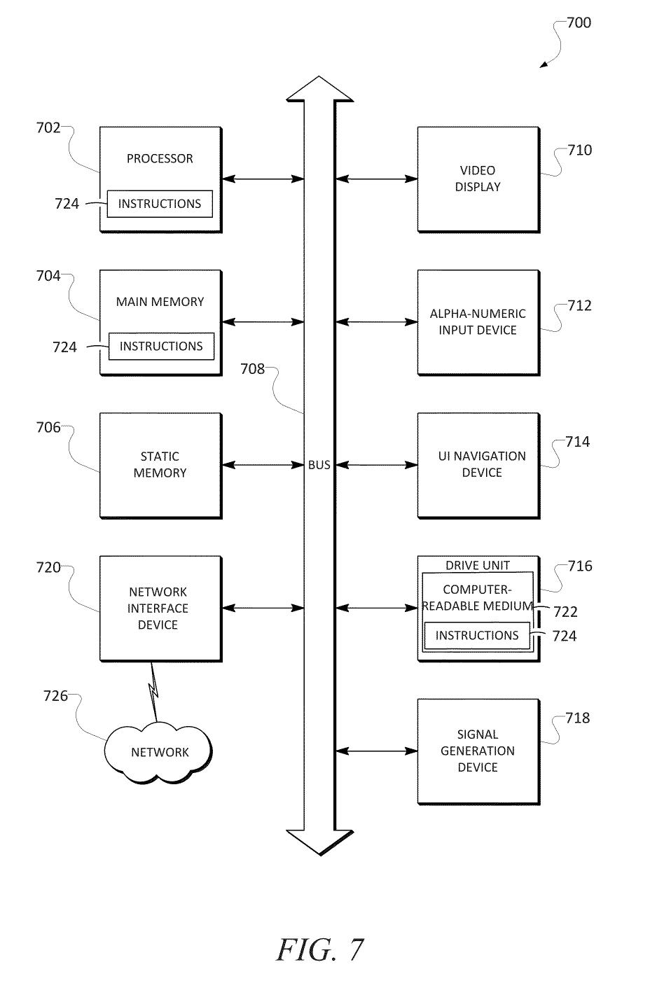

FIG. 7 is a block diagram of a machine in the example form of a computer system 700 within which instructions 724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation (e.g., cursor control) device 714 (e.g., a mouse), a drive unit 716, a signal generation device 718 (e.g., a speaker) and a network interface device 720.

### Machine-Readable Medium

The drive unit 716 includes a computer-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting computer-readable media 722.

While the computer-readable medium 722 is shown in an example embodiment to be a single medium, the term “computer-readable medium” may include a single medium or multiple media (e.g., a centralized or distributed database, and/or associated caches and servers) that store the one or more instructions 724 or data structures. The term “computer-readable medium” shall also be taken to include any tangible medium that is capable of storing, encoding, or carrying instructions 724 for execution by the machine and that cause the machine to perform any one or more of the methodologies of the present disclosure, or that is capable of storing, encoding, or carrying data structures utilized by or associated with such instructions 724. Thus the term “computer-readable medium” excludes signals per se. The term “computer-readable medium” shall accordingly be taken to include, but not be limited to, solid-state memories, and optical and magnetic media. Specific examples of computer-readable media 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMAX networks). The term “transmission medium” shall be taken to include any intangible medium that is capable of storing, encoding, or carrying instructions 724 for execution by the machine, and includes digital or analog communications signals or other intangible media to facilitate communication of such software.

Although the inventive subject matter has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed:

1. A system comprising:
a location module configured to determine, using a processor of a machine, a location of a first user device based on received location data;
a device identification module configured to identify the first user device, based on user device data;
a path prediction module configured to predict a path of the first user device;
a communications module configured to deliver content to the first user device; and
a user interface module configured to cause display of an interactive user interface.

2. The system of claim 1, wherein the user device data includes one or more antenna identifiers corresponding to the first user device including Bluetooth antenna identifiers and Wi-Fi antenna identifiers.

3. The system of claim 1, wherein the location data corresponds to a beacon identifier.

4. The system of claim 1, wherein the device identification module identifies the first user device in response to the first user device entering a vicinity of a beacon located at a crosswalk.

5. The system of claim 1, wherein the device identification module is further configured to identify a second user device in proximity to the first user device, wherein the second user device has the same predicted path as the first user device; and
the communications module is further configured to deliver paired content to the first user device and the second user device.

6. The system of claim 1, wherein the location module is further configured to determine that the first user device is moving away from the location; and
the communications module is further configured to deliver incentivized content to the first user device, wherein the incentivized content varies in relation to a distance from the location.

7. The system of claim 1, wherein the communications module is further configured to deliver the content to a second user device.

8. The system of claim 1, wherein the communications module is further configured to deliver the content to the first user device by a push notification.

9. The system of claim 1, wherein the path prediction module is further configured to generate a predicted path of the user device based on historical paths taken by one or more other user devices.

10. A method comprising:
receiving location data and user device data corresponding to a first user device;
identifying the first user device based on the user device data;
predicting, based on the location data and the user device data, a path of the first user device; and
delivering targeted content based on the path.

11. The method of claim 10, wherein the user device data includes one or more antenna identifiers corresponding to the first user device including a Bluetooth antenna identifier and a Wi-Fi antenna identifier.

12. The method of claim 10, wherein the location data corresponds to a beacon identifier.

13. The method of claim 10, wherein the receiving of the location data and the user device data is in response to the first user device entering a vicinity of a beacon;
wherein the beacon is located at a crosswalk.

14. The method of claim 10 further comprising:
identifying a second user device in proximity to the first user device, the second user device having the same predicted path as the first user device; and
delivering paired content to the second user device and the first user device, wherein the paired content includes a group discount.

15. The method of claim 10 further comprising:
determining that the first user device is moving away from a location; and
delivering incentivized content to the first user device, wherein the incentivized content varies in relation to a distance of the first user device from the location.

16. The method of claim 15 wherein an incentive corresponding to the incentivized content increases in relation to the distance of the first user device from the location.

17. The method of claim 10 further comprising sharing the targeted content delivered to the first user device, wherein:
the first user device is a touch-enabled device; and
the sharing of the targeted content is executed through a recognized gesture on the touch-enabled device.

18. The method of claim 10 wherein the targeted content is delivered to the first user device by a push notification.

19. The method of claim 10 wherein the targeted content is delivered to the first user device by an email.

20. The method of claim 10 further comprising generating a predicted path based on historical paths taken by one or more other user devices.
